(19) United States
(12) Patent Application Publication
(10) Pub. No.: US 2020/0314703 A1
(43) Pub. Date: Oct. 1, 2020

(54) Notification Method for Releasing Terminal Context, Network Device, and Computer Storage Medium

(71) Applicant: GUANGDONG OPPO MOBILE TELECOMMUNICATIONS CORP., LTD., Dongguan (CN)

(72) Inventor: Jianhua Liu, Dongguan (CN)

(21) Appl. No.: 16/900,301

(22) Filed: Jun. 12, 2020

Related U.S. Application Data
(63) Continuation of application No. PCT/CN2017/118292, filed on Dec. 25, 2017.

(51) Int. Cl. H04W 36/00; H04W 36/08; H04W 36/14

(52) U.S. Cl. CPC H04W 36/0033; H04W 36/08; H04W 36/00835; H04W 36/0055; H04W 36/0022; H04W 36/14

(57) ABSTRACT

Disclosed are a notification method for releasing a terminal context, a network node, and a computer storage medium. The method includes: when a terminal converts from being connected to a second network node to being connected to a first network node, or, when the terminal converts from being connected to a second communication system to being connected to a first communication system, the first network node transmits a first notification to the second network node or to the second communication system, where the first notification at least is used for notifying the second communication system or the second network node to release a context of the terminal; and when the terminal is connected to the second communication system or connected to the second network node, the second communication system or the second network node saves the context of the terminal.

### CROSS-REFERENCE TO RELATED APPLICATION(S)

This application is a continuation application of International Application No. PCT/CN2017/118292, filed on Dec. 25, 2017, the entire disclosure of which is hereby incorporated by reference.

### TECHNICAL FIELD

The present disclosure relates to the technical field of information processing, in particular to a notification method for releasing a context of a terminal, network nodes and a computer storage medium.

### BACKGROUND

After a terminal establishes a connection with a first communication system, if it is for some reason, for example, some services are not supported in the first communication system, the terminal may try to access a second communication system for these services. For some terminals with certain capabilities, they can only communicate in one communication system at the same time. When the terminal accesses the second communication system, a network node of the first communication system does not know that the terminal is no longer in the first communication system, which will cause that the terminal and the network have asymmetric state information of the terminal.

### SUMMARY

To solve the above technical problem, implementations of the present disclosure provide a notification method for releasing a context of a terminal, network nodes and a computer storage medium.

An implementation of the present disclosure provides a notification method for releasing a context of a terminal, applied to a first network node. The method includes: when a terminal switches from accessing a second network node to accessing the first network node or when the terminal switches from accessing a second communication system to accessing a first communication system, the first network node sends a first notification to the second network node or the second communication system; wherein, the first notification is at least used for notifying the second communication system or the second network node to release the context of the terminal, when the terminal accesses the second communication system or the second network node, the context of the terminal is stored in the second communication system or the second network node.

An implementation of the present disclosure provides a notification method for releasing a context of a terminal, applied to a second network node. The method includes: when a terminal switches from accessing a second communication system to accessing a first communication system or when the terminal switches from accessing the second network node to accessing a first network node, the second network node receives a first notification sent from the first communication system or the first network node, wherein, the first notification is at least used for notifying to release the context of the terminal; when the terminal accesses the second communication system or the second network node, there is a connection between the terminal and the second communication system or the second network node, and the context of the terminal is stored in the second communication system or the second network node.

An implementation of the present disclosure provides a first network node, including: a first processing unit, which, when a terminal switches from accessing a second network node to accessing the first network node or when the terminal switches from accessing a second communication system to accessing a first communication system, controls a first communication unit to send a first notification to the second network node or the second communication system; and the first communication unit, which sends the first notification to the second network node or the second communication system.

Herein, the first notification is at least used for notifying the second communication system or the second network node to release a context of the terminal, when the terminal accesses the second communication system or the second network node, the context of the terminal is stored in the second communication system or the second network node.

An implementation of the present disclosure provides a second network node, including: a second processing unit, which, when a terminal switches from accessing a second communication system to accessing a first communication system or when the terminal switches from accessing the second network node to accessing a first network node, receives a first notification sent from the first communication system or the first network node through a second communication unit; and the second communication unit, which receives the first notification sent from the first communication system or the first network node.

Herein, the first notification is at least used for notifying to release a context of the terminal; when the terminal accesses the second communication system or the second network node, there is a connection between the terminal and the second communication system or the second network node, and the context of the terminal is stored in the second communication system or the second network node.

An implementation of the present disclosure provides a network node including a processor and a memory for storing a computer program that is capable of being run on the processor. Herein, the processor is configured to, when running the computer program, perform the acts of the above methods.

An implementation of the present disclosure provides a computer storage medium, the computer storage medium stores computer executable instructions, and when the computer executable instructions are executed, acts of the above methods are implemented.

### BRIEF DESCRIPTION OF DRAWINGS

FIG. 1 is a schematic flowchart one of a notification method for releasing a context of a terminal according to an implementation of the present disclosure.

FIG. 2 is a schematic flowchart two of a notification method for releasing a context of a terminal according to an implementation of the present disclosure.

FIG. 3 is a schematic diagram of structure of a first network node according to an implementation of the present disclosure.

FIG. 4 is a schematic diagram of structure of a second network node according to an implementation of the present disclosure.

FIG. 5 is a schematic diagram of a hardware architecture according to an implementation of the present disclosure.

### DETAILED DESCRIPTION

To understand features and technical contents of implementations of the present disclosure in more detail, implementations of the implementations of the present disclosure will be described in detail below with reference to the drawings, which are used for reference only and are not intended to limit the implementations of the present disclosure.

Implementation One

An implementation of the present disclosure provides a notification method for releasing a context of a terminal, applied to a first network node. The method includes: when a terminal switches from accessing a second network node to accessing the first network node or when the terminal switches from accessing a second communication system to accessing a first communication system, the first network node sends a first notification to the second communication node or the second communication system; wherein, the first notification is at least used for notifying the second communication system or the second network node to release the context of the terminal; when the terminal accesses the second communication system or the second network node, there is a connection between the terminal and the second communication system or the second network node, and the context of the terminal is stored in the second communication system or the second network node.

In addition, the first network node is located in the first communication system. The second network node may be located in the first communication system, or in another communication system, for example, may be located in the second communication system.

Specifically, the implementation of the present disclosure provides the following two processing scenarios.

Scenario One

When a terminal switches from accessing a second network node to accessing a first network node, the first network node sends a first notification to the second network node; wherein, the first notification is at least used for notifying the second network node to release a context of the terminal, when the terminal accesses the second network node, the context of the terminal is stored in the second network node.

Herein, the terminal establishes a connection with the second network node when accessing the second network node.

A trigger condition for the terminal to switch access may be that the terminal finds the second network node currently serving the terminal cannot meet a requirement of the terminal, thus the terminal switches to the first network node that can meet the usage requirement of the terminal.

It should be pointed out that the above first network node and second network node may belong to the same communication system or belong to different communication systems respectively. The first and second network nodes may be core network nodes or access network nodes or the like.

Further, when the terminal switches from accessing the second network node to accessing the first network node, the method may further include: acquiring identification information of the second network node reported by the terminal.

In addition, the method may further include: acquiring a second notification sent from the terminal, wherein the second notification is used for indicating to send the first notification to the second network node.

The first notification further includes identification information of the terminal. Herein, the identification information of the terminal may include IMSI, IMEI or other information as long as the terminal can be uniquely identified.

The second notification further includes a cause value. Herein, the cause value is used for indicating a reason for triggering to send the first notification to the second communication system or the second network node. That is, the reason for releasing a connection and a context of the terminal is carried in the second notification message, for example, the reason is that the terminal has left the second network node.

Further, the method of sending the first notification to the second network node may include: sending the first notification to the second network node through an interface with the second network node; or, sending the first notification to the second network node through a third party node.

Herein, the interface between the first network node and the second network node may be a physical interface or a wireless interface, which is not limited here.

The third party node is a network element connected both with the first communication network and with the second communication network; or, the third party node is a network element connected both with the first network node and with the second network node.

For example, the third party node may be a core network element or an access network element or an operation and maintenance network element that is connected with the first and second network nodes.

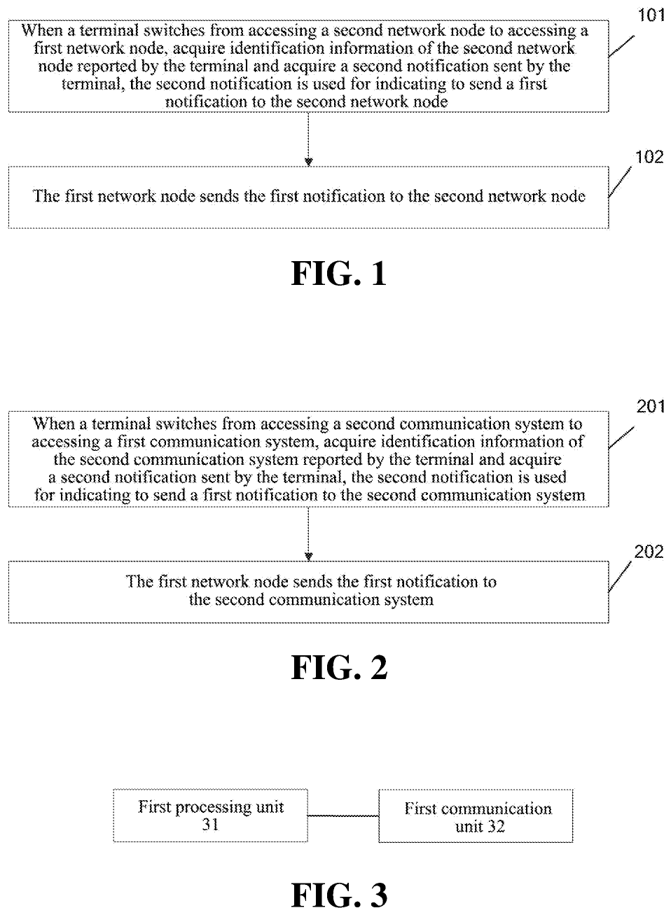

This scenario may be as shown in FIG. 1, which includes acts 101 and 102.

In act 101, when a terminal switches from accessing a second network node to accessing a first network node, identification information of the second network node reported by the terminal is acquired, and a second notification sent by the terminal is acquired; the second notification is used for indicating to send a first notification to the second network node.

In act 102, the first network node sends the first notification to the second network node.

Scenario Two

When a terminal switches from accessing a second communication system to accessing a first communication system, a first network node sends a first notification to the second communication system; wherein, the first notification is at least used for notifying the second communication system to release a context of the terminal; when the terminal accesses the second communication system, the context of the terminal is stored in the second communication system.

Herein, when accessing the second communication system, the terminal establishes a connection with a network node in the second communication system. It should be pointed out that in this scenario, when the connection with the second communication system is established, the connection may be established with a second network node in the second communication system, or the connection may be established with a network node other than the second network node in the second communication system, which is not specifically limited.

A trigger condition for the terminal to switch an accessed communication system may be that the terminal finds the second communication system currently serving the terminal cannot meet a requirement of the terminal, thus the terminal switches to the first communication system that can meet the usage requirement of the terminal. Here, the meeting the requirement of the terminal may be that the terminal may need to access a certain service while the service, such as 4G, is not provided by the existing second communication system, and the terminal will switch to access the first communication system, such as LTE. It may be understood that the foregoing is only a trigger example, and in fact, there may be other ways, which are not exhaustively enumerated in the present implementation.

It should be pointed out that the first communication system and the second communication system support different communication standards and/or support at least partially different service types. Specifically, the first and second communication systems may be 3GPP cellular network systems such as a 5G system or a 4G system, or non-3GPP systems such as WLAN. The first and second network nodes may be core network nodes or access network nodes or the like.

Further, when the terminal switches from accessing the second communication system to accessing the first communication system, the method may further include acquiring identification information of the second communication system reported by the terminal.

Here, the reported identification information of the second communication system may be a reported identification of the second communication system, or reported identification information of the second network node, which establishes a connection with the terminal, in the second communication system, as long as the originally accessed second communication system can be represented.

In addition, the method may further include: acquiring a second notification sent from the terminal, and the second notification is used for indicating to send the first notification to the second communication system.

The first notification further includes identification information of the terminal. Herein, the identification information of the terminal may include IMSI, IMEI or other information as long as the terminal can be uniquely identified.

The second notification further includes a cause value. Herein, the cause value is used for indicating a reason for triggering to send the first notification to the second communication system or the second network node. That is, the reason for releasing a connection and a context of the terminal is carried in the second notification message, for example, the reason is that the terminal has left the second network node.

Further, the method of sending the first notification to the second communication system may include: sending the first notification to the second communication system through an interface with the second communication system; or, sending the first notification to the second communication system through an interface with a network node of the second communication system; wherein, the interface of the network node of the second communication system may be an interface of an edge device via which the second communication system acquires information sent from other devices or other networks; or, sending the first notification to the second network node through a third party node.

The third party node is a network element connected both with the first communication network and with the second communication network; or, the third party node is a network element connected both with the first network node and with the second network node. For example, the third party node may be a core network element or an access network element or an operation and maintenance network element that is connected with the first and second network nodes.

This scenario may be as shown in FIG. 2, which includes acts 201 and 202.

In act 201, when a terminal switches from accessing a second communication system to accessing a first communication system, identification information of the second communication system reported by the terminal is acquired and a second notification sent by the terminal is acquired; the second notification is used for indicating to send a first notification to the second communication system.

In act 202, the first network node sends the first notification to the second communication system.

It can be seen that by adopting the above solution, when a terminal switches from one network node or communication system to another network node or communication system, a first notification may be sent to the network node or communication system originally accessed by the terminal, so that the originally accessed network node or communication system releases a connection or releases a context of the terminal. In this way, a problem that the originally accessed network or node still maintains the context of the terminal when the terminal has connected to another system is avoided, such that the network nodes or systems adopting the above solution achieve an effect of symmetrical state information of the terminal.

Implementation Two

An implementation of the present disclosure provides a notification method for releasing a context of a terminal, applied to a second network node. The method includes: when a terminal switches from accessing a second communication system to accessing a first communication system or when a terminal switches from accessing a second network node to accessing a first network node, the second network node receives a first notification sent from the first communication system or the first network node; wherein, the first notification is at least used for notifying to release a context of the terminal; when the terminal accesses the second communication system or the second network node, there is a connection between the terminal and the second communication system or the second network node, and the context of the terminal is stored in the second communication system or the second network node.

In addition, the first network node is located in the first communication system. The second network node may be located in the first communication system, or in another communication system, for example, may be located in the second communication system.

Specifically, when the terminal switches from accessing the second network node to accessing the first network node, the first network node sends the first notification to the second network node. Herein, the first notification is at least used for notifying the second network node to release the context of the terminal; when the terminal accesses the second network node, the context of the terminal is stored in the second network node.

Herein, the terminal establishes a connection with the second network node when accessing the second network node.

A trigger condition for the terminal to switch access may be that the terminal finds the second network node currently serving the terminal cannot meet a requirement of the terminal, thus the terminal switches to the first network node that can meet the usage requirement of the terminal.

It should be pointed out that the above first network node and second network node may belong to the same communication system or belong to different communication systems respectively.

The first network node is a network node of a core network or an access network in the first communication system, and the second network node is a network node of a core network or an access network in the second communication system.

In the present implementation, the second network node may be a node located in the second communication system. Of course, the second network node may be a node located in the first communication network. Correspondingly, the first network node may be located in the first communication system or the second communication system.

The first communication system and the second communication system support different communication standards and/or support at least partially different service types.

Specifically, the first and second communication systems may be 3GPP cellular network systems such as a 5G system or a 4G system, or non-3GPP systems such as WLAN. The first and second network nodes may be core network nodes or access network nodes or the like.

Further, receiving the first notification sent from the first communication system or the first network node includes: receiving the first notification through an interface with the first communication system; or, receiving the first notification through an interface connected with the first network node; or, receiving the first notification through a third party node.

Herein, the interface between the first network node and the second network node may be a physical interface or a wireless interface, which is not limited here.

Further, after the second network node of the second communication system receives the first notification sent from the first network node of the first communication system, the method further includes that the second network node notifies a third network node that stores a connection of the terminal or the context of the terminal to release the connection of the terminal or release the context of the terminal.

That is, when the third network node stores the connection of the terminal or the context of the terminal, the second network node may act as a forwarding node, and control the third network node to release the connection of the terminal or release the context of the terminal based on the first notification.

The third party node is a network element connected both with the first communication network and with the second communication network; or, the third party node is a network element connected both with the first network node and with the second network node. For example, the third party node may be a core network element or an access network element or an operation and maintenance network element that is connected with the first and second network nodes.

It can be seen that by adopting the above solution, when a terminal switches from one network node or communication system to another network node or communication system, a first notification can be sent to the network node or communication system originally accessed by the terminal, so that the originally accessed network node or communication system releases a connection or releases a context of the terminal. In this way, a problem that the originally accessed network or node still maintains the context of the terminal when the terminal has connected to another system is avoided, such that the network nodes or systems adopting the above solution achieve an effect of symmetrical state information of the terminal.

Implementation Three

An implementation of the present disclosure provides a first network node. As shown in FIG. 3, the first network node includes a first processing unit 31, which, when a terminal switches from accessing a second network node to accessing the first network node or when the terminal switches from accessing a second communication system to accessing a first communication system, controls a first communication unit to send a first notification to the second network node or the second communication system; and the first communication unit 32, which sends the first notification to the second network node or the second communication system.

Herein, the first notification is at least used for notifying the second communication system or the second network node to release a context of the terminal. When the terminal accesses the second communication system or the second network node, there is a connection between the terminal and the second communication system or the second network node, and the context of the terminal is stored in the second communication system or the second network node.

In addition, the first network node is located in the first communication system. The second network node may be located in the first communication system or in another communication system, for example, may be located in the second communication system.

Specifically, the implementation of the present disclosure provides the following two processing scenarios.

Scenario One

When a terminal switches from accessing a second network node to accessing the first network node, the first processing unit 31 sends a first notification to the second network node through the first communication unit 32; wherein the first notification is at least used for notifying the second network node to release a context of the terminal; when the terminal accesses the second network node, the context of the terminal is stored in the second network node.

Herein, the terminal establishes a connection with the second network node when accessing the second network node.

A trigger condition for the terminal to switch access may be that the terminal finds the second network node currently serving the terminal cannot meet a requirement of the terminal, thus the terminal switches to the first network node that can meet the usage requirement of the terminal.

It should be pointed out that the above first network node and second network node may belong to the same communication system or belong to different communication systems respectively. The first and second network nodes may be core network nodes or access network nodes or the like.

Further, when the terminal switches from accessing the second network node to accessing the first network node or when the terminal switches from accessing the second communication system to accessing the first communication system, the first processing unit acquires the identification information of the second network node reported by the terminal through the first communication unit 32.

In addition, when the terminal switches from accessing the second network node to accessing the first network node or when the terminal switches from accessing the second communication system to accessing the first communication system, the first processing unit acquires the second notification sent from the terminal through the first communication unit 32, and the second notification is used for indicating to send the first notification to the second network node.

The first notification further includes identification information of the terminal. Herein, the identification information of the terminal may include IMSI, IMEI or other information as long as the terminal can be uniquely identified.

The second notification further includes a cause value, wherein the cause value is used for indicating a reason for triggering to send the first notification to the second communication system or the second network node. That is, the reason for releasing a connection and the context of the terminal is carried in the second notification message, for example, the reason is that the terminal has left the second network node.

Further, the first communication unit 32 sends the first notification to the second network node through an interface with the second network node; or, sends the first notification to the second network node through a third party node.

Herein, the interface between the first network node and the second network node may be a physical interface or a wireless interface, which is not limited here.

The third party node is a network element connected both with the first communication network and with the second communication network; or, the third party node is a network element connected both with the first network node and with the second network node. For example, the third party node may be a core network element or an access network element or an operation and maintenance network element that is connected with the first and second network nodes.

Scenario Two

When a terminal switches from accessing a second communication system to accessing a first communication system, the first processing unit sends a first notification to the second communication system through the first communication unit. Herein, the first notification is at least used for notifying the second communication system to release a context of the terminal, and when the terminal accesses the second communication system, the context of the terminal is stored in the second communication system.

Herein, when accessing the second communication system, the terminal establishes a connection with a network node in the second communication system. It should be pointed out that in this scenario, when the connection with the second communication system is established, the connection may be established with a second network node in the second communication system, or the connection may be established with a network node other than the second network node in the second communication system, which is not specifically limited.

A trigger condition for the terminal to switch an accessed communication system may be that the terminal finds the second communication system currently serving the terminal cannot meet a requirement of the terminal, thus the terminal switches to the first communication system that can meet the usage requirement of the terminal. The meeting the requirement of the terminal here may be that the terminal may need to access a certain service, while the service, such as 4G, is not provided in the existing second communication system, and the terminal will switch to access the first communication system, such as LTE. It can be understood that the foregoing is only a trigger example, in fact, there may be other ways, but it is not exhaustively enumerated in the present implementation.

It should be pointed out that the first communication system and the second communication system support different communication standards and/or support at least partially different service types. Specifically, the first and second communication systems may be 3GPP cellular network systems such as a 5G system or a 4G system, or non-3GPP systems such as WLAN. The first and second network nodes may be core network nodes or access network nodes or the like.

Further, when the terminal switches from accessing the second communication system to accessing the first communication system, the first processing unit acquires identification information of the second communication system reported by the terminal through the first communication unit.

Here, the reported identification information of the second communication system may be reported identification of the second communication system or reported identification information of the second network node, which establishes the connection with the terminal, in the second communication system, as long as the originally accessed second communication system can be represented.

In addition, when the terminal switches from accessing the second network node to accessing the first network node or when the terminal switches from accessing the second communication system to accessing the first communication system, the first processing unit acquires a second notification sent from the terminal through the first communication unit, and the second notification is used for indicating to send the first notification to the second communication system.

The first notification further includes identification information of the terminal. Herein, the identification information of the terminal may include IMSI, IMEI or other information as long as the terminal can be uniquely identified.

The second notification further includes a cause value, wherein the cause value is used for indicating a reason for triggering to send the first notification to the second communication system or a second network node. That is, the reason for releasing the connection and the context of the terminal is carried in the second notification message, for example, the reason is that the terminal has left the second network node.

Further, the method of sending the first notification to the second communication system may include: sending the first notification to the second communication system through an interface with the second communication system; or, sending the first notification to the second communication system through an interface with a network node of the second communication system; wherein, the interface of the network node of the second communication system may be an interface of an edge device via which the second communication system acquires information sent from other devices or other networks; or, sending the first notification to the second network node through a third party node.

The third party node is a network element connected both with the first communication network and with the second communication network; or, the third party node is a network element connected both with the first network node and with the second network node.

For example, the third party node may be a core network element or an access network element or an operation and maintenance network element that is connected with the first and second network nodes.

It can be seen that by adopting the above solution, when a terminal switches from one network node or communication system to another network node or communication system, a first notification can be sent to the network node or communication system originally accessed by the terminal, so that the originally accessed network node or communication system releases a connection or releases a context of the terminal. In this way, a problem that the originally accessed network or node still maintains the context of the terminal when the terminal has connected to another system is avoided, thus the network nodes or systems adopting the above solution achieve an effect of symmetrical state information of the terminal.

Implementation Four

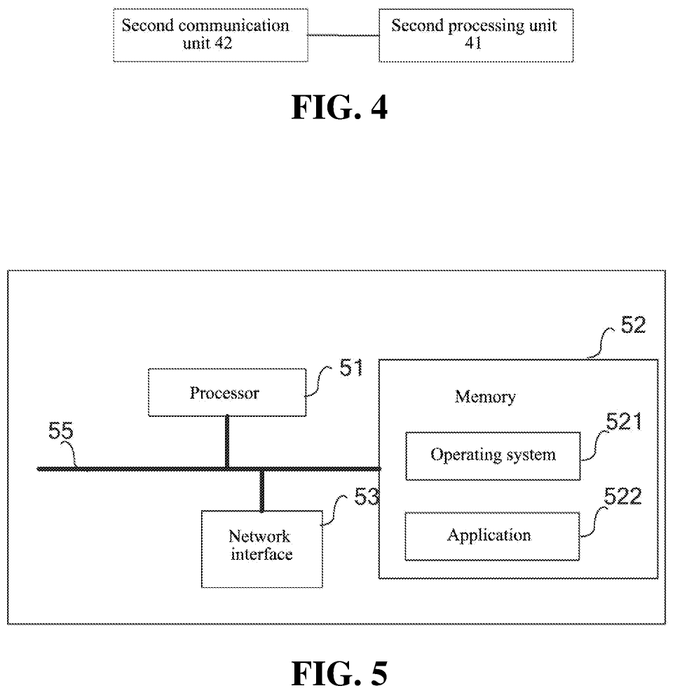

An implementation of the present disclosure provides a second network node. As shown in FIG. 4, the second network node includes a second processing unit 41, which, when a terminal switches from accessing a second communication system to accessing a first communication system or when the terminal switches from accessing the second network node to accessing a first network node, receives a first notification sent from the first communication system or the first network node through a second communication unit; and the second communication unit 42, which receives the first notification sent from the first communication system or the first network node.

Herein, the first notification is at least used for notifying to release a context of the terminal. When the terminal accesses the second communication system or the second network node, there is a connection between the terminal and the second communication system or the second network node, and the context of the terminal is stored in the second communication system or the second network node.

In addition, the first network node is located in the first communication system. The second network node may be located in the first communication system or in another communication system, for example, may be located in the second communication system.

A trigger condition for the terminal to switch access may be that the terminal finds the second network node currently serving the terminal cannot meet a requirement of the terminal, thus the terminal switches to the first network node that can meet the usage requirement of the terminal.

It should be pointed out that the above first network node and second network node may belong to the same communication system or belong to different communication systems respectively.

The first network node is a network node of a core network or an access network in the first communication system.

The second network node is a network node of a core network or an access network in the second communication system.

In the present implementation, the second network node may be a node located in the second communication system. Of course, the second network node may be a node located in the first communication network. Correspondingly, the first network node may be located in the first communication system or the second communication system.

The first communication system and the second communication system support different communication standards and/or support at least partially different service types. Specifically, the first and second communication systems may be 3GPP cellular network systems such as a 5G system or a 4G system, or non-3GPP systems such as WLAN. The first and second network nodes may be core network nodes or access network nodes or the like.

Further, the second communication unit 42 receives a first notification through an interface with the first communication system; or, receives the first notification through an interface connected with the first network node; or, receives the first notification through a third party node.

Herein, the interface between the first network node and the second network node may be a physical interface or a wireless interface, which is not limited here.

Further, after the second network node of the second communication system receives the first notification sent from the first network node of the first communication system, the second communication unit 42 notifies a third network node that stores a connection or the context of the terminal to release the connection of the terminal or release the context of the terminal.

That is, when the connection of the terminal or the context of the terminal is stored in the third network node, the second network node may act as a forwarding node, and control the third network node to release the connection of the terminal or release the context of the terminal based on the first notification.

The third party node is a network element connected both with the first communication network and with the second communication network; or, the third-party node is a network element connected both with the first network node and with the second network node.

For example, the third party node may be a core network element or an access network element or an operation and maintenance network element that is connected with the first and second network nodes.

It can be seen that by adopting the above solution, when a terminal switches from one network node or communication system to another network node or communication system, a first notification can be sent to the network node or communication system originally accessed by the terminal, so that the originally accessed network node or communication system releases a connection or releases a context of the terminal. In this way, a problem that the originally accessed network or node still maintains the context of the terminal when the terminal has connected to another system is avoided, thus the network nodes or systems adopting the above solution achieve an effect of symmetrical state information of the terminal.

An implementation of the present disclosure further provides an architecture of hardware composition of the first network node or second network node, which includes at least one processor 51, a memory 52, and at least one network interface 53, as shown in FIG. 5. Various components are coupled together by a bus system 54. It may be understood that the bus system 54 is used for implementing connections and communications between these components. In addition to a data bus, the bus system 54 includes a power bus, a control bus, and a status signal bus. However, for clarity, all kinds of buses are uniformly referred to as the bus system 54 in the FIG. 5.

It should be understood that the memory 52 in the implementation of the present disclosure may be a volatile memory or a non-volatile memory, or it may include both volatile and non-volatile memory.

In some implementations, the memory 52 stores following elements, executable modules or data structures, or subsets thereof, or extended sets thereof: operating system 521 and application 522.

Herein, the processor 51 is configured to be capable of processing acts of the methods in the implementation one or the implementation one, and the acts are not described repeatedly here.

An implementation of the present disclosure provides a computer storage medium storing computer executable instructions, and when the computer executable instructions are executed, the acts of the methods in the implementation one or the implementation two are implemented.

The above device in the implementations of the present disclosure may also be stored in a computer readable storage medium when it is implemented in the form of a software function module and sold or used as an independent product. Based on this understanding, the technical solutions in the implementations of the present disclosure, in essence, or the part contributing to the prior art, may be embodied in the form of a software product stored in a storage medium, including several instructions for causing a computer device (which may be a personal computer, a server, or a network device, etc.) to perform all or part of the methods in various implementations of the present disclosure. The aforementioned storage medium includes a U disk, a mobile hard disk, a read-only memory (ROM), a magnetic disk or an optical disk, and another media capable of storing program codes. Thus, the implementations of the present disclosure are not limited to any specific combination of hardware and software.

Correspondingly, an implementation of the present disclosure further provides a computer storage medium in which a computer program is stored, and the computer program is configured to execute the data scheduling method in the implementations of the present disclosure.

Although the preferable implementations of the present disclosure have been disclosed for illustrative purposes, those skilled in the art will recognize that various modifications, additions and substitutions are possible, and therefore, the scope of the present disclosure should not be limited to the above implementations.

What is claimed is:

1. A method of notification for releasing a context of a terminal, applied to a first network node, the method comprising:
sending, by the first network node, a first notification to a second network node or a second communication system when a terminal switches from accessing the second network node to accessing the first network node or when the terminal switches from accessing the second communication system to accessing a first communication system;
wherein the first notification is at least used for notifying the second communication system or the second network node to release the context of the terminal; when the terminal accesses the second communication system or the second network node, the context of the terminal is stored in the second communication system or the second network node.

2. The method of claim 1, wherein when the terminal switches from accessing the second network node to accessing the first network node or when the terminal switches from accessing the second communication system to accessing the first communication system, the method further comprises:
acquiring identification information of the second communication system or the second network node reported by the terminal.

3. The method of claim 2, wherein when the terminal switches from accessing the second network node to accessing the first network node or when the terminal switches from accessing the second communication system to accessing the first communication system, the method further comprises:
acquiring a second notification sent by the terminal; wherein the second notification is used for indicating to send the first notification to the second communication system or the second network node.

4. The method of claim 1, wherein the first notification further comprises identification information of the terminal.

5. The method of claim 3, wherein the second notification further comprises a cause value, wherein the cause value is used for indicating a reason for triggering to send the first notification to the second communication system or the second network node.

6. The method of claim 1, wherein the first communication system and the second communication system support at least one of: different communication standards, or at least partially different service types.

7. A first network node, comprising a first processor and a first network interface, wherein
the first processor is configured to control the first network interface to send a first notification to a second network node or a second communication system when a terminal switches from accessing the second network node to accessing the first network node or when the terminal switches from accessing the second communication system to accessing a first communication system; and
the first network interface is configured to send the first notification to the second network node or the second communication system;
wherein the first notification is at least used for notifying the second communication system or the second network node to release a context of the terminal; when the terminal accesses the second communication system or the second network node, the context of the terminal is stored in the second communication system or the second network node.

8. The first network node of claim 7, wherein
when the terminal switches from accessing the second network node to accessing the first network node or when the terminal switches from accessing the second communication system to accessing the first communication system, the first processor is configured to acquire identification information of the second communication system or the second network node reported by the terminal through the first network interface.

9. The first network node of claim 8, wherein when the terminal switches from accessing the second network node to accessing the first network node or when the terminal switches from accessing the second communication system to accessing the first communication system, the first processor is configured to acquire a second notification sent from the terminal through the first network interface, wherein the second notification is used for indicating to send the first notification to the second communication system or the second network node.

10. The first network node of claim 7, wherein the first notification further comprises identification information of the terminal.

11. The first network node of claim 9, wherein the second notification further comprises a cause value, wherein the cause value is used for indicating a reason for triggering to send the first notification to the second communication system or the second network node.

12. The first network node of claim 9, wherein the first network interface is configured to send the first notification to the second communication system through an interface with the second communication system; or,
send the first notification to the second communication system through an interface with a network node of the second communication system; or,
send the first notification to the second network node through an interface with the second network node; or,
send the first notification to the second communication system or the second network node through a third party node.

13. The first network node of claim 7, wherein the first network node is a network node of a core network or an access network in the first communication system, and the second network node is a network node of a core network or an access network in the second communication system.

14. The first network node of claim 12, wherein the third party node is a network element connected both with the first communication network and with the second communication network; or, the third party node is a network element connected both with the first network node and with the second network node.

15. A second network node, comprising a second processor and a second network interface, wherein
the second processor is configured to receive a first notification sent from a first communication system or a first network node through the second network interface when a terminal switches from accessing a second communication system to accessing the first communication system or when the terminal switches from accessing the second network node to accessing the first network node; and
the second network interface is configured to receive the first notification sent from the first communication system or the first network node;
wherein the first notification is at least used for notifying to release a context of the terminal; when the terminal accesses the second communication system or the second network node, there is a connection between the terminal and the second communication system or the second network node, and the context of the terminal is stored in the second communication system or the second network node.

16. The second network node of claim 15, wherein the second network interface is configured to receive the first notification through an interface with the first communication system; or,
receive the first notification through an interface connected with the first network node; or,
receive the first notification through a third party node.

17. The second network node of claim 15, wherein the first communication system and the second communication system support at least one of different communication standards, or at least partially different service types.

18. The second network node of claim 15, wherein the first network node is a network node of a core network or an access network in the first communication system, and the second network node is a network node of a core network or an access network in the second communication system.

19. The second network node of claim 16, wherein the third party node is a network element connected both with the first communication network and with the second communication network; or, the third party node is a network element connected both with the first network node and with the second network node.

20. The second network node of claim 15, wherein the second processor is further configured to notify, through the second network interface, a third network node that stores a connection of the terminal or the context of the terminal to release the connection of the terminal or the context of the terminal.
